(19) United States
(12) Patent Application Publication
(10) Pub. No.: US 2012/0297066 A1
(43) Pub. Date: Nov. 22, 2012

(54) METHOD AND SYSTEM FOR APPARATUS MEANS FOR PROVIDING A SERVICE REQUESTED BY A CLIENT IN A PUBLIC CLOUD INFRASTRUCTURE

(75) Inventor: Andrew John Hewett, Erlangen (DE)

(73) Assignee: SIEMENS AKTIENGESELLSCHAFT, Munich (DE)

(21) Appl. No.: 13/111,200

(22) Filed: May 19, 2011

(51) Int. Cl. G06F 15/173

(52) U.S. Cl. 709/226

(57) ABSTRACT

A method and a system are disclosed for providing a service requested by a client in a public cloud infrastructure including at least one cloud service server and at least one on-premise server being the initial contact point for the service. In at least one embodiment, transparency is provided to the client in that client does not know if the service is running on-premise or in the cloud. It ensures that an instance of the service is always accessible.

### FIELD

At least one embodiment of the present invention generally relates to a method and a system and/or apparatus means for providing a service requested by a client in a public cloud infrastructure comprising at least one cloud service server.

At least one embodiment of the invention can be used in the network infrastructure for healthcare applications.

### BACKGROUND

Running software services in a public cloud infrastructure normally incurs costs even when the service is unused. Public cloud providers charge on an hourly basis for deployed services irrespective of execution state (i.e. the same charges are incurred if the service is running or suspended).

Cloud providers typically provide mechanisms to start additional instances of a service to handle additional clients, users or load. However, if no instance of a service is running then the service cannot be used. Moreover, it typically takes several minutes (up to 20 minutes) to start a new instance of a service. Even for infrequently used applications this means that at least one instance of a service must be running whenever a client might need access which, depending on the operational scenario, can mean running at least one instance of the service.

The problem is to allow a cloud service to be deployed on-demand while remaining accessible even when no instances are deployed to the cloud.

This problem can be solved either by running the service only using on-premise hardware or by running only in the cloud.

The disadvantages of using only on-premise hardware are:

1. The on-premise hardware is expensive since it must be dimensioned to support the maximum number concurrent users
2. The network connection is expensive since it be dimensioned to support the bandwidth required by the maximum number concurrent users.

The disadvantages of using only cloud infrastructure are:

1. The service is relatively expensive since it must be deployed and running on the cloud provider infrastructure even when unused. Often it will be necessary to run one instance of the service.

It is possible to use Cloud Service Bus. The concept of a Cloud Service Bus allows on-premise services located behind a firewall to be accessed from internet clients. A concept of a so-called Cloud Service Hosting can provide on-demand computing and storage to host, scale and manage internet accessible services in large data centers.

### SUMMARY

At least one embodiment of the present invention overcomes at least one of the above mentioned problems.

At least one embodiment of the present invention solves at least one of the problems. Preferred embodiments of the invention are described in the dependent claims.

The solution exposed by at least one embodiment of the invention is to combine a minimal on-premise service with an on-demand cloud service in such a way that the service location is transparent to the service user while minimizing cloud hosting costs and resources. A technical aspect of at least one embodiment of the invention is a fluent and transparent (to the client) relocation of service between on-premise and cloud.

At least one embodiment of the invention enables switching between on-premise and cloud services, allowing cloud services to be started and stopped all while maintaining transparency to the client. At least one embodiment of the invention is most applicable for reducing the cost of cloud services which have unpredictable periods of inactivity. An example for such a service might be result distribution for a small radiology department where referring physicians access results at irregular times.

Furthermore, at least one embodiment of the invention enables cloud service costs and resources to be minimized while keeping the major cloud benefit of high scalability. The standard cloud computing technique of starting additional service instances can still be utilized to handle a large number of clients.

At least one embodiment of the invention allows a minimal on-premise server to be the initial contact point for a cloud service. Since the on-premise server must only handle a few clients it can be dimensioned minimally. This contrasts with the dimensioning needed for traditional on-premise services required to support peak load.

The cloud service is started when needed and stopped when unused. This allows costs for cloud services to be minimized. Cloud providers normally charge per hour for deployed services even when inactive.

The Cloud Service Bus concept is used in a novel way to provide transparency in that client does not know if the service is running on-premise or in the cloud. The routing information used by the Cloud Service Bus is switched in a way that ensures that an instance of the service is always accessible. The Cloud Service Bus can be a software and/or a hardware module.

### BRIEF DESCRIPTION OF THE DRAWINGS

Preferred embodiments of the present invention will now be described with reference to the accompanying drawings in which:

FIG. 1 is a schematic diagram showing how to to access a cloud service and

FIG. 2 schematically shows the interaction to stop the cloud service.

### DETAILED DESCRIPTION OF THE EXAMPLE EMBODIMENTS

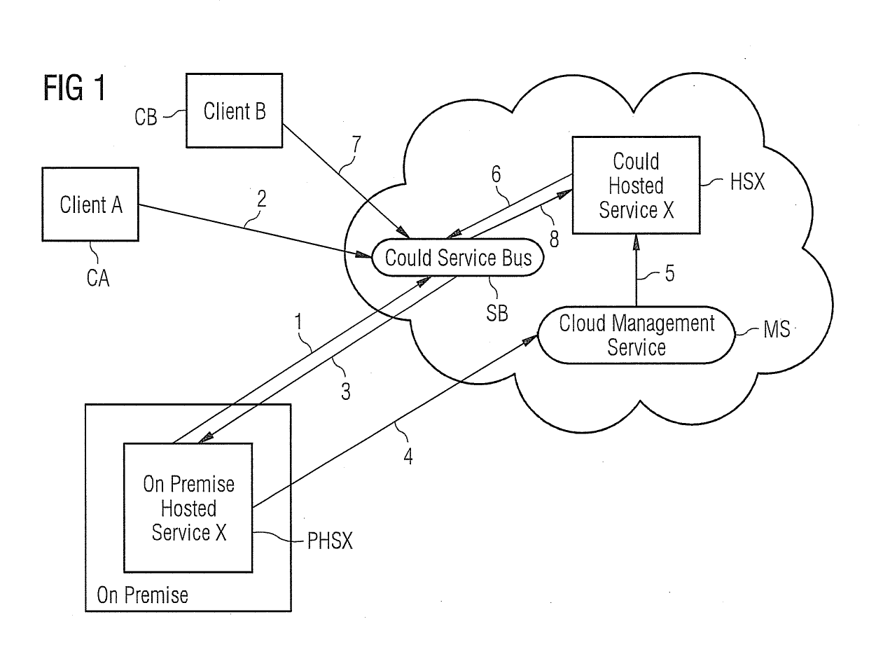

FIG. 1 generally depicts how to access and/or start a cloud service using an embodiment of the invention and contains e.g. the following entities:
Client A CA/Client B CB: client applications such as Web Browsers or Windows applications located anywhere and attached to the internet.
Cloud Hosted Service X HSX: an instance of the service running in the cloud provider infrastructure.
Cloud Service Bus SB: a service bus which can route messages from a source to one or more destinations. This entity is typically part of the cloud provider infrastructure (e.g. Windows Azure Service Bus).
Cloud Management Service MS: a management service which provides an API (application programming interface) to start (and stop) cloud services. This is part of the cloud provider infrastructure (e.g. Windows Azure Management API).
On Premise Hosted Service X PHSX: is an instance of the service hosted somewhere outside the cloud. This will typically be at a location under control of the person/organization offering the service.

In the following steps—marked in FIG. 1 with 1, 2, 3, 4, 5, 6, 7 and 8—possible key interactions are described:

### Step

1 The On Premise Hosted Service X PHSX instructs the Cloud Service Bus SB to forward all messages for Service X to the On Premise Hosted Service X PHSX.
2 Client A CA sends a request for Service X which is not (at this time) running in the cloud to the Cloud Service Bus SB.
3 The Cloud Service Bus SB relays this message to the On Premise Hosted Service X PHSX which performs the service request and responds with the results.
4 If the On Premise Hosted Service X PHSX determines that sufficient reason exists to start a cloud version of Service X it requests the Cloud Management Service MS to start one or more instances of Cloud Hosted Service X HSX. It may need to upload a copy of the service to the cloud before the instance can be started.
5 The Cloud Management Service MS starts an instance of Cloud Hosted Service X HSX. There can be a delay of several minutes before the service is operational since the cloud infrastructure has to spin up a virtual machine and possibly wake up sleeping server hardware resources within the cloud provider data center.
6 When the Cloud Hosted Service X HSX is operational it requests the Cloud Service Bus SB to route all messages for Service X to itself. The message routing is changed only when the service is completely operational to ensure that an instance of the service is always accessible.
7 Some other Client B CB sends a request for Service X to the Cloud Service Bus SB.
8 The Cloud Service Bus SB relays this message to the Cloud Hosted Service X HSX which performs the service request and responds with the results.

The Cloud Hosted Service X HSX can start additional instances of itself using the Cloud Management Service MS to handle additional clients.

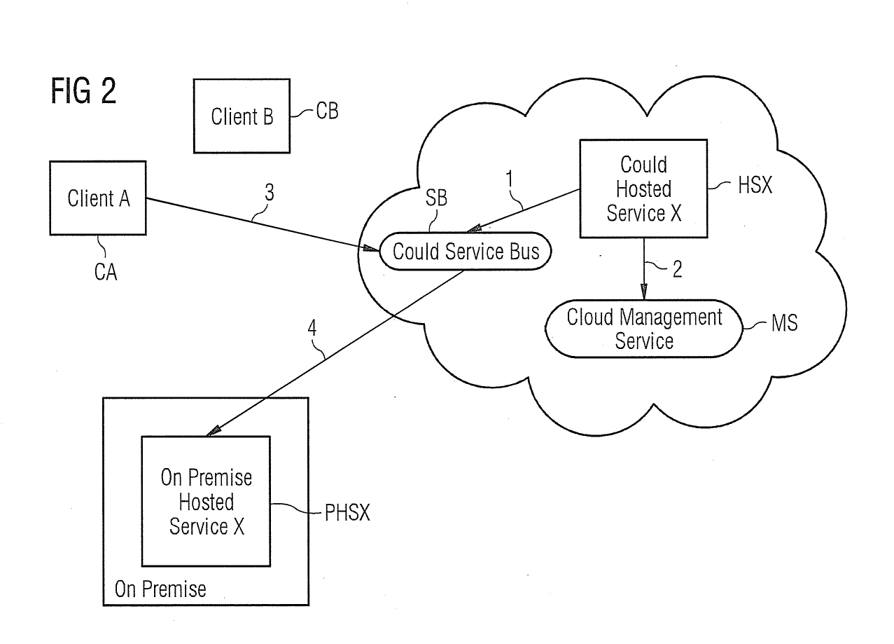

FIG. 2 shows interactions to stop the cloud service:

### Step

1 The Cloud Hosted Service X HSX uses some rules to determine that it no longer needs to be operational (e.g. no requests have been received for x minutes). It requests the Cloud Service Bus SB to route all messages for Service X to the On Premise Hosted Service X PHSX. The change of message routing is performed before the Cloud Hosted Service X HSX terminates to ensure that an instance of ServiceX is always accessible.
2 The Cloud Hosted Service X HSX requests the Cloud Management Service MS to remove all instances of Service X. Depending on the cloud provider it may only be necessary for the Cloud Hosted Service X HSX to perform a normal shut down.
3 Requests from Client A CA (or any other client) will now to routed by the Cloud Service Bus SB to On Premise Hosted Service X PHSX.
4 On Premise Hosted Service X PHSX performs the service request and responds with the results.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a tangible computer readable medium and is adapted to perform any one of the aforementioned methods when run on a computer device (a device including a processor). Thus, the tangible storage medium or tangible computer readable medium, is adapted to store information and is adapted to interact with a data processing facility or computer device to execute the program of any of the above mentioned embodiments and/or to perform the method of any of the above mentioned embodiments.

The tangible computer readable medium or tangible storage medium may be a built-in medium installed inside a computer device main body or a removable tangible medium arranged so that it can be separated from the computer device main body. Examples of the built-in tangible medium include, but are not limited to, rewriteable non-volatile memories, such as ROMs and flash memories, and hard disks. Examples of the removable tangible medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for providing a service requested by a client in a public cloud infrastructure comprising at least one cloud service server and at least one on-premise server being an initial contact point for the service, the method comprising:
switching routing of service messages in a way that enables at least one of starting, running and stopping of the service on the at least one on-premise server or on the cloud server while maintaining transparency to the client.

2. A method according to claim 1, wherein at least an instance of the service is always accessible.

3. A method according to claim 1, wherein the at least one on-premise server only handles a few clients which are minimally dimensionable.

4. A method according to claim 2, wherein the at least one on-premise server only handles a few clients which are minimally dimensionable.

5. A system for providing a service requested by a client in a public cloud infrastructure, comprising:
at least one cloud service server;
at least one on-premise server being an initial contact point for the service; and
at least one cloud service bus module to route service messages in a way that enables at least one of starting, running and stopping the service on the at least one on-premise server or on the cloud server while maintaining transparency to the client.

6. A system according to claim 5, wherein at least an instance of the service is always accessible.

7. A system according to claim 5, wherein the at least one on-premise server is only in contact with a few clients which are minimally dimensionable.

8. A system according to claim 6, wherein the at least one on-premise server is only in contact with a few clients which are minimally dimensionable.

9. A tangible computer readable medium including program segments for, when executed on a computer device, causing the computer device to implement the method of claim 1.

10. A system for providing a service requested by a client in a public cloud infrastructure, comprising:
at least one on-premise server being an initial contact point for the service; and
at least one cloud service bus module to route service messages in a way that enables at least one of starting, running and stopping the service on the at least one on-premise server or on a remotely located cloud server while maintaining transparency to the client.

11. A system according to claim 10, wherein at least an instance of the service is always accessible.

12. A system according to claim 10, wherein the at least one on-premise server is only in contact with a few clients which are minimally dimensionable.

13. A system according to claim 11, wherein the at least one on-premise server is only in contact with a few clients which are minimally dimensionable.
